(19) United States
(12) Patent Application Publication
(10) Pub. No.: US 2025/0230062 A1
(43) Pub. Date: Jul. 17, 2025

(54) CONTROLLER AND METHOD FOR CONTROLLING A WATER TREATMENT SYSTEM

(71) Applicant: Franklin Electric Co., Inc., Fort Wayne, IN (US)

(72) Inventors: Adrian Chavis, Fort Wayne, IN (US); Shawn B. Massie, Saint Paris, OH (US); Benjamin W. Schafer, Auburn, IN (US); Bart Long, Fort Wayne, IN (US); Matthew D. Rumple, Fort Wayne, IN (US)

(21) Appl. No.: 19/019,272

(22) Filed: Jan. 13, 2025

Related U.S. Application Data
(60) Provisional application No. 63/620,416, filed on Jan. 12, 2024.

(51) Int. Cl. C02F 1/00; C02F 1/42

(52) U.S. Cl. CPC C02F 1/008; C02F 1/42; C02F 2201/005; C02F 2209/003; C02F 2209/40; C02F 2209/44; C02F 2303/16

(57) ABSTRACT

A water treatment device, comprising: a controller operably connected to a tank containing a water softening resin; a sensor in communication with the controller and configured to provide date for determining a treatment capacity of the water softening resin and for determining a quantity of water treated by the water softening resin; and a valve configured to pass water to be treated through the water softening resin; wherein the controller is configured to monitor a remaining treatment capacity of the water softening resin by subtracting the quantity of water treated by the water softening resin from the treatment capacity of the water softening resin; and wherein the controller is configured to record the remaining treatment capacity, as a negative value, when the quantity of water treated by the water softening resin exceeds the treatment capacity of the water softening resin.

### CROSS-REFERENCE TO RELATED APPLICATIONS

This application claims the benefit under 35 U.S.C. § 119(e) and priority to U.S. Provisional Application Ser. No. 63/620,416, filed on Jan. 12, 2024, the entire disclosure of which being expressly incorporated herein by reference.

### TECHNICAL FIELD

The present disclosure relates to water treatment systems and, in particular, to a controller and method for controlling water treatment systems.

### BACKGROUND

Water treatment systems commonly include one or more different filtration or water softener units configured to deliver potable water to an end user. These units can include membrane filters (for removing contaminants), water softeners (for ion exchange), and media filtration units (for removing dissolved solids or organic compounds).

Typically, water treatment systems are used to remove undesirable minerals (such as calcium, magnesium, manganese, and iron) from mineral-rich or “hard” water. These systems may employ an ion exchange process to bond the undesirable minerals to other materials, such as salts, to deliver treated or “soft” water to the end user. Such ion exchange may be accomplished by providing an ion exchange resin bed containing resin materials designed to promote the ion exchange process. The resin bed is typically housed in a tank filled by an untreated water source. As the untreated water passes through the resin bed, ions of calcium and other positively charged ions are exchanged with ions held by the resin. Undesirable hardness minerals are thereby removed from the water and replaced with ions from the resin.

The ion exchange capacity of the resin materials is gradually depleted as the ion exchange process is repeated over time. Thus, the resin materials need to be periodically regenerated. This regeneration can be accomplished by chemically replacing the undesirable ions bonded to the resin during the water softening process (such as calcium) with sodium or similar ions. In some systems, regeneration includes passing a regenerant solution of sodium or potassium chloride through the resin bed.

The regeneration process may include a number of cycles, including, for example, a backwash cycle to remove turbidity from the resin bed, a brine draw cycle to introduce the regenerant to the resin bed, a rinse cycle to eliminate chlorides in the finished water, and a brine refill cycle to prepare a brine solution for the next regeneration. To effect distribution of the regenerant solution, a control valve may be attached to the top of the water softener tank. The control valve includes a structure for directing the flow of fluid to complete the regeneration process, such as a reciprocating piston, rotating disc or poppets.

As the system operates, the sodium or potassium ions from the brine solution will be exchanged in the resin bed to positively ionize the resin beads. Over time the salt/potassium will diminish and will need to be restored to continue softening hard water. Typically, the brine solution is located in a brine storage tank with a user-accessible interior cavity, such that the user can periodically refill the storage tank with additional water softening salt/potassium as the brine concentration level drops.

### SUMMARY

In one embodiment, the present disclosure provides a method for regenerating water softening resin in a tank, the method comprising the steps of: preventing water from flowing through the water softening resin; determining a quantity of water treated by the water softening resin; determining a treatment capacity of the water softening resin; and passing a quantity of brine solution through the water softening resin, the quantity of brine solution corresponding to the treatment capacity of the water softening resin and the quantity of water treated by the water softening resin that exceeds the treatment capacity of the water softening resin. In one aspect of this embodiment, determining a quantity of water treated by the water softening resin includes sensing, by a flow meter, a quantity of water that has passed through the water softening resin since a previous regeneration operation. In another aspect, passing a quantity of brine solution through the water softener resin includes, automatically initiating, by a controller, a regeneration operation using an increased amount of brine solution.

In another embodiment, the present disclosure provides a water treatment device, comprising: a controller operably connected to a tank containing a water softening resin; a sensor in communication with the controller and configured to provide date for determining a treatment capacity of the water softening resin and for determining a quantity of water treated by the water softening resin; and a valve configured to pass water to be treated through the water softening resin; wherein the controller is configured to monitor a remaining treatment capacity of the water softening resin by subtracting the quantity of water treated by the water softening resin from the treatment capacity of the water softening resin; and wherein the controller is configured to record the remaining treatment capacity, as a negative value, when the quantity of water treated by the water softening resin exceeds the treatment capacity of the water softening resin. In one aspect of this embodiment, the controller is further configured to respond to the quantity of water treated by the water softening resin exceeding the treatment capacity of the water softening resin by causing an increased amount of brine solution to be provided to the water softening resin to ensure that the water softening resin is replenished.

In yet another embodiment, the present disclosure provides a method for treating water using a water treatment system, the method comprising the steps of: providing a control module including a user interface and a real-time-clock with a calendar function, the control module operatively connected to the water treatment system; displaying, on the user interface, a calendar and a current time; collecting from a user, a selection of a time of day and at least one day of the week on which the water treatment system should perform regeneration; using the real-time clock to keep track of the current time and day of the week and to identify a start time for regeneration corresponding to the time and the at least one day of the week selected by the user; and initiating, by the controller, regeneration of the water treatment system at the start time identified by the real-time clock. In one aspect of this embodiment, collecting includes collecting from the user a selection of a plurality of days of the week on which the water treatment system should perform regeneration.

In another embodiment, the present disclosure provides a method for treating water using at least two water conditioners, the method comprising the steps of: providing a three-way motor-actuated valve (MAV) operatively connected to at least one input port of each of the at least two water conditioners; determining which of the at least two water conditioners requires regeneration; and actuating the MAV to prevent water from flowing through the input port of the water conditioner requiring regeneration and to allow water to flow through the at least one input port of the other water conditioner which does not require regeneration. In one aspect of this embodiment, the method further comprises providing treated water from an output port of the other water conditioner to the at least one water conditioner requiring regeneration. In another aspect, the at least two water conditioners are coupled to a single brine tank.

In still another embodiment, the present disclosure provides a method for treating water using at least two water conditioners, the method comprising the steps of: providing a three-way motor-actuated valve (MAV) operatively connected to at least one output port of each of the at least two water conditioners; determining which of the at least two water conditioners requires regeneration; and actuating the MAV to prevent water from flowing through the output port of the water conditioner requiring regeneration and to allow water to flow through the at least one output input port of the other water conditioner which does not require regeneration. In one aspect of this embodiment, the method further comprises providing untreated water from a water source to the input port of the at least one water conditioner requiring regeneration. In another aspect, the at least two water conditioners are coupled to a single brine tank.

In another embodiment, the present disclosure provides a method of preventing accumulation of debris in a motor-actuated valve (MAV), the method comprising the steps of: determining a sequence start time based on a predetermined cadence or based on user input; at the sequence start time, actuating the MAV in a first direction from an original position for a first predetermined amount of time then in a second direction for a second predetermined amount of time; and actuating the MAV in the first direction for a third predetermined amount of time to move the MAV back to the original position.

In another embodiment, the present disclosure provides a method of controlling a direct-current motor, the method comprising the steps of: providing a controller operatively connected to the direct-current motor; providing an initial voltage of a first polarity to actuate the direct-current motor in a first direction using the controller; determining whether the direct-current motor rotates in the first direction or in a second direction; and responding to the direct-current motor rotating in the second direction by automatically configuring software executed by the controller to provide a subsequent voltage of a second polarity which is opposite of the first polarity to the direct-current motor to actuate the direct-current motor in the first direction. In one aspect of this embodiment, the method further comprises displaying an input polarity flip option on a user interface of the controller and receiving, via the user interface, an input from a user indicating that the direct-current motor rotates in the second direction after providing the initial voltage to the direct-current motor. In another aspect, the initial voltage and the subsequent voltage are provided from the controller to a controller connector which is connected to a motor connector connected to the direct-current motor.

In still another embodiment, the present disclosure provides a method for regenerating water softening resin of a water treatment system comprising the steps of: providing a valve comprising at least one piston; providing at least one ancillary device operably associated with the valve; providing a tank containing the water softening resin, the tank operatively connected to the valve; receiving a user input for at least one regeneration stage of a Stage ON time, a Stage ON Offset, a Stage OFF time and a Stage OFF Offset for the at least one ancillary device; activating the at least one ancillary device at the Stage ON time plus the Stage On Offset; and deactivating the at least one ancillary device at the Stage OFF time plus the Stage OFF Offset; whereby the activation and deactivation of the at least one ancillary device is independent of a duration of the at least one regeneration stage. In one aspect of this embodiment, the at least one ancillary device is one of a relay or a motor-actuated valve. In another aspect, activation of the at least one ancillary device may occur before or after a movement of the piston corresponding to the at last one regeneration stage, or between movements of the piston corresponding to a first regeneration stage and a subsequent second regeneration stage.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a schematic view of a motor-actuated valve (“MAV”) connected to the outputs of two water softener valves showing the MAV receiving treated water from the first water softener valve while the second water softener valve is in a standby mode;

FIG. 2 is the schematic view of FIG. 1 showing the MAV receiving treated water from the second water softener valve while the first water softener valve is in a regeneration mode;

FIG. 3 is a schematic view of the MAV receiving treated water from the first water softener while the second water softener is in a regeneration mode;

FIG. 4 is a schematic view of a MAV connected to the inputs of two water softener valves showing the MAV directing water from a source to the first water softener valve while the second water softener is in a standby mode;

FIG. 5 is the schematic view of FIG. 4 showing the MAV directing water from a source to the second water softener valve while the first water softener is in a regeneration mode;

FIG. 6 is a schematic view of the MAV directing water to the first water softener while the second water softener is in a regeneration mode;

FIG. 7 is a schematic view of a dual water treatment system, in accordance with the present disclosure;

FIG. 8 is a block diagram of a control module for a water treatment system, including a sensing unit, a drive unit and a user interface;

FIG. 9 is a timing diagram representing a regeneration operation for a water softening device;

FIGS. 10-15 are timing diagrams depicting the operation of various ancillary devices during the regeneration operation of FIG. 9 according to one embodiment of the present disclosure;

FIG. 16 is a conceptual diagram of a sensing unit and a drive unit of a water softening device, showing the connection between a controller connector and a motor connector; and

FIG. 17 is a flowchart showing a process for changing polarity of a motor without manually removing pins from the motor connector of FIG. 16.

Corresponding reference characters indicate corresponding parts throughout the several views. Unless stated otherwise the drawings are not proportional or drawn to scale.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings.

For purposes of the present disclosure, directionality will be referenced in the context of a typical use of a water softening system. Thus, an “upper” or “top” feature is considered to be vertically above a “lower” or “bottom” feature as viewed in a typical water softener installation.

Water Softener/Filter Dual Alt. System Using a Master Controller

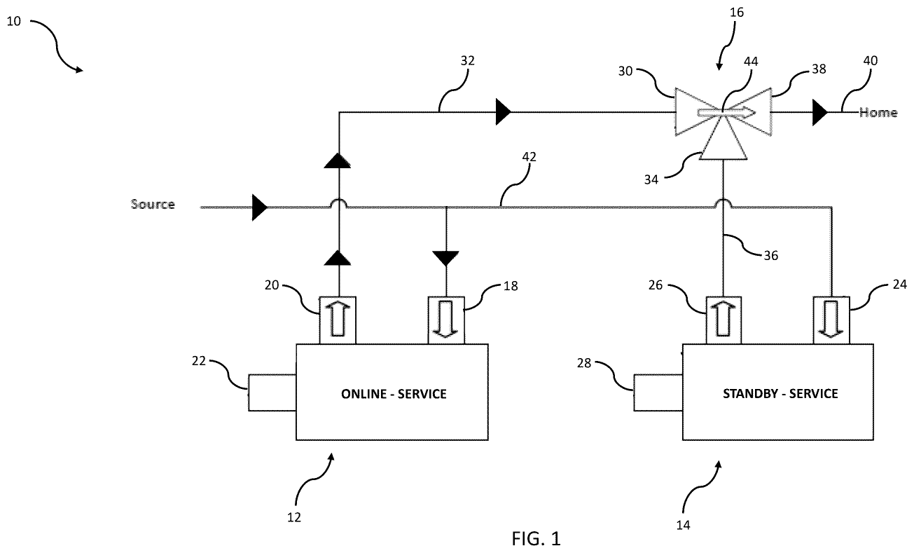

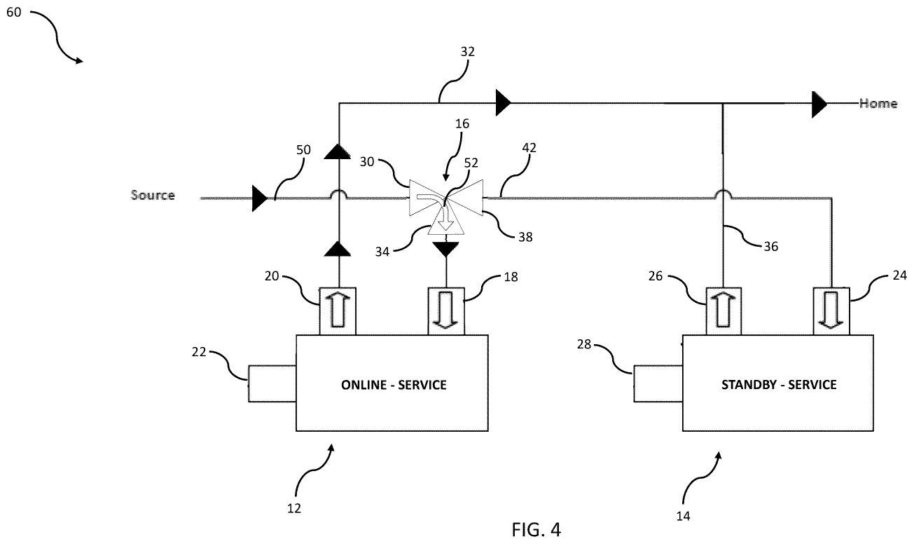

Referring now to FIGS. 1-3, an exemplary embodiment of a dual water treatment system 10 is shown. The system generally includes a first water conditioner 12, a second water conditioner 14 and a motor actuated valve (“MAV”) 16. The first and second water conditioners 12, 14 include a variety of components for the treatment of water as is known in the art. For purposes of this description, the first water conditioner 12 includes an input port 18, an output port 20 and a discharge port 22. Similarly, the second water conditioner 14 includes an input port 24, an output port 26 and a discharge port 28. The MAV 16 is, in exemplary embodiments, a single, 3-port valve that generally moves water between either the first water conditioner 12 and the second water conditioner 14 and then to the home. In FIGS. 1-3, the MAV 16 is shown connected to the output ports 20, 26 of the first water conditioner 12 and the second water conditioner 14, respectively. As described below with reference to FIGS. 4-6, the MAV 16 may alternatively be connected to the input ports 18, 24 of the first water conditioner 12 and the second water conditioner 14, respectively.

More specifically with reference to FIGS. 1-3, the MAV 16 includes a first port 30 fluidly coupled to the output port 20 of the first water conditioner 12 by line 32, a second port 34 fluidly coupled to the output port 26 of the second water conditioner 14 by line 36, and a third port 38 fluidly coupled by line 40 to a plumbing system (not shown) for a water consuming facility, such as a home. A source of water, such as a municipal supply or a well, is fluidly coupled to the input ports 18, 24 of the first water conditioner 12 and the second water conditioner 14 by a line 42. The MAV 16 is configured to electrically communicate with one of the first water conditioner 12 or the second water conditioner 14, either through wire connections, wirelessly or some combination of both. Additionally, the first water conditioner 12 and the second water conditioner 14 may, in certain embodiments, communicate with each other. In this manner, the position of the MAV 16 is always known, which may provide for easier set up. In the configuration depicted in FIGS. 1-3, the user sets a parameter on the first water conditioner 12 that the MAV 16 is operating in a dual alt system. While the MAV 16 may operate to provide various other functions, the first water conditioner 12 has to know that the MAV 16 is in a dual alt system to then operate as described below. In this configuration, a water meter (not shown) of the system 10 is connected to the first water conditioner 12 and a flow meter (not shown) of the second water conditioner 14 is disabled.

In operation in this example, the first water conditioner 12 which is connected to the MAV 16 actually controls the operation of the MAV 16 by communicating the logical sequence and control signals to the MAV 16. The MAV 16 moves between an opened position and a closed position depending upon which of the first water conditioner 12 and the second water conditioner 14 requires regeneration. In FIG. 1, the MAV 16 is shown in the closed position. When in the closed position, the MAV 16 places the second water conditioner 14 in a standby mode, such that the second water conditioner 14 does not provide water to the MAV 16 for distribution to the home through line 40. The MAV 16 places the first water conditioner 12 in an online mode, such that the first water conditioner 12 provides water through output port 20 and the line 32 to the first port 30 of the MAV 16 which, in the closed position, directs the water through the third port 38 and the line 40 to the home, as depicted by the arrow 44.

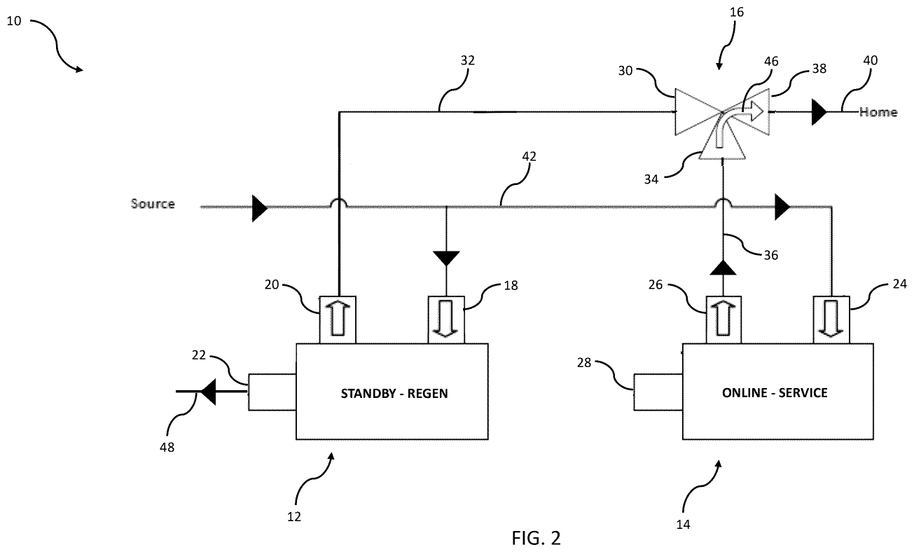

Referring now to FIG. 2, the MAV 16 responds to the request for regeneration from the first water conditioner 12 by moving to the open position. When in the open position, the MAV 16 places the second water conditioner 14 in an online mode, such that the second water conditioner 14 provides water through the output port 26 and the line 36 to the second port 34 of the MAV 16 which, in the open position, directs the water through the third port 38 and the line 40 to the home, as depicted by the arrow 46. The MAV 16 places the first water conditioner 12 in a regeneration mode, such that the first water conditioner 12 receives water from the source through the line 42 to the inlet port 18, performs regeneration, and discharges water through the discharge port 22 and through the line 48 to a drain (not shown).

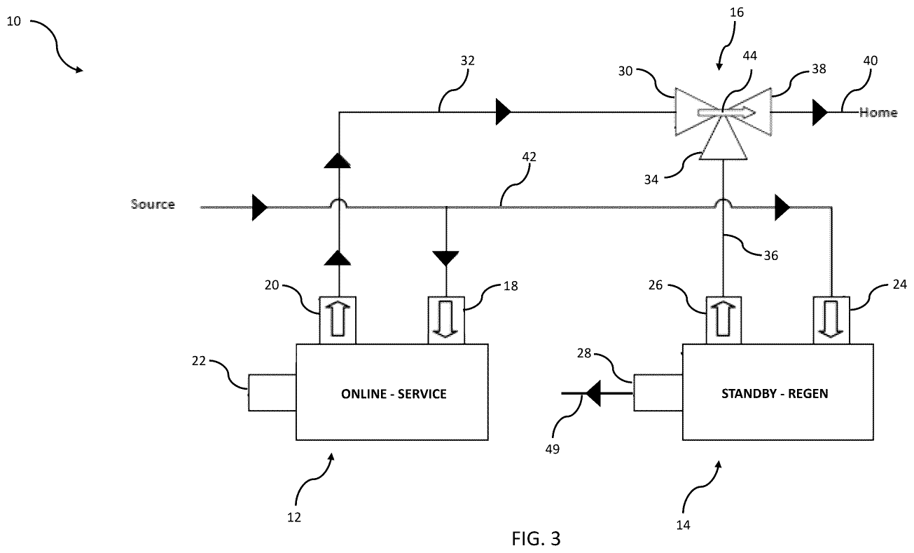

As shown in FIG. 3, when the second water conditioner 14 requests regeneration, the MAV 16 moves to the closed position. The MAV 16 places the second water conditioner 14 in a regen mode, such that the second water conditioner 14 receives water from the source through the line 42 to the inlet port 24, performs regeneration, and discharges water through the discharge port 28 and through the line 49 to a drain (not shown). The MAV 16 places the first water conditioner 12 in an online mode, such that the first water conditioner 12 provides water through the output port 20 and the line 32 to the first port 30 of the MAV 16 which, in the closed position, directs the water through the third port 38 and the line 40 to the home, as depicted by the arrow 44.

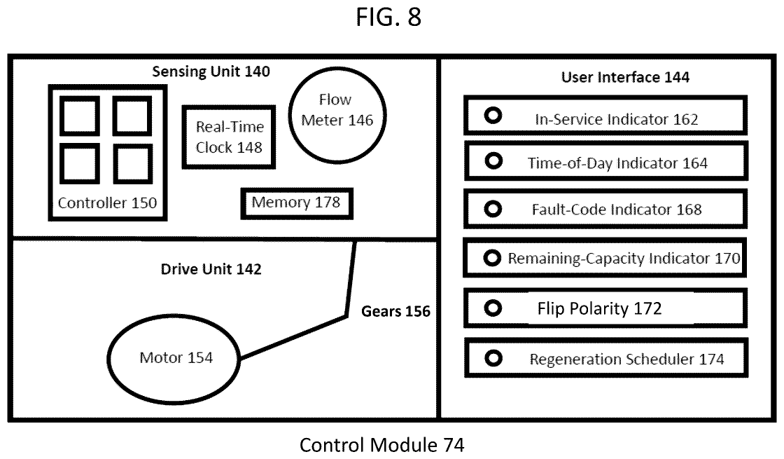

In the manner described above, the MAV 16 alternates as needed to accommodate the regeneration schedules of the first water conditioner 12 and the second water conditioner 14 between the opened position (FIG. 2), wherein the first water conditioner 12 performs regeneration and the second water conditioner 14 provides water service to the home, and the closed position (FIG. 3), wherein the second water conditioner 14 performs regeneration and the first water conditioner 12 provides water service to the home. It should be understood that to provide continuous water service to the home, only one of the first water conditioner 12 and the second water conditioner 14 are permitted to perform regeneration at a time. In certain embodiments, the water conditioner (12 or 14) providing service to the home displays an “online” message on a user interface 144 (FIG. 8) of a control module 74 of the water conditioner. In certain embodiments, the water conditioner (12 or 14) not providing service to the home displays a “standby” message on the user interface 144 of the water conditioner.

In an exemplary embodiment, when a flow meter 144 (FIG. 8) of the second water conditioner 14 is disabled, the first water conditioner 12 communicates to the second water conditioner 14 flow meter pulses and the flow measurements of the first water conditioner 12 in pulses per gallon used. In a typical water conditioner setup, the flow meter 144 is located on the output port (20 and 26) of one of the water conditioners 12, 14. In alternative embodiments, to reduce cost, the flow meters 144 of each of the first water conditioner 12 and the second water conditioner 14 may be removed, and a flow meter 144 may be placed to sense water flow on line 40 (going to the home). Then, the flow meter 144 may be wired to one of the water conditioners 12, 14. The flow meter 144 puts out pulses corresponding to flow rate. Since the water conditioners 12, 14 are communicating to each other, the water conditioner 12, 14 connected to flow meter 144 can send pulses to the other water conditioner, which then translates the pulses to flow rate.

In certain embodiments, if a fault occurs on one of the first water conditioner 12 or the second water conditioner 14, the MAV 16 moves to the appropriate position (i.e., either the opened position or the closed position) to provide service to the home using the water conditioner not experiencing the fault, and stays in position during regeneration. When a water conditioner executes a regeneration operation, the internal valve creates the pathway to discharge the fluid through discharge ports 22 and 28. This is not dependent on position of MAV 16. Also during regeneration, the internal valve creates a shortcut pathway between the inlet port and the outlet port in case there is a demand for water from the home. In this scenario, if the home demands water during a regeneration, then the water will not be “softened,” but instead will be the same hardness as the water from the source. Thus, if one of the water conditioners 12, 14 is in a fault-state, the other water conditioner 12, 14 can continue as a normal water conditioner but the customer will have hard-water during regeneration. According to the principles of the present disclosure, the dua alt system is configured to provide softened water to the home during regeneration. As described below with reference to FIGS. 4-6, the present disclosure may provide the additional benefit of performing regeneration with softened water.

Referring now to FIGS. 4-6, another embodiment of a water treatment system 60 is shown. As shown, the second port 34 of the MAV 16 is coupled to the input port 18 of the first water conditioner 12 and the third port 38 of the MAV 16 is coupled to the input port 24 of the second water conditioner 14. In the configuration shown in FIG. 4, the MAV 16 is shown in a first position wherein the MAV 16 places the second water conditioner 14 in a standby mode and the first water conditioner 12 in an online mode. As such, supply water flows from the source through line 50 into the first port 30 of the MAV 16, out the second port 34 of the MAV 16 (as indicated by arrow 52) and into the input port 18 of the first water conditioner 12. The water is conditioned in the first water conditioner 12 and flows out the output port 20 through line 32 to the home. Water from the source is not provided to the second water conditioner 14.

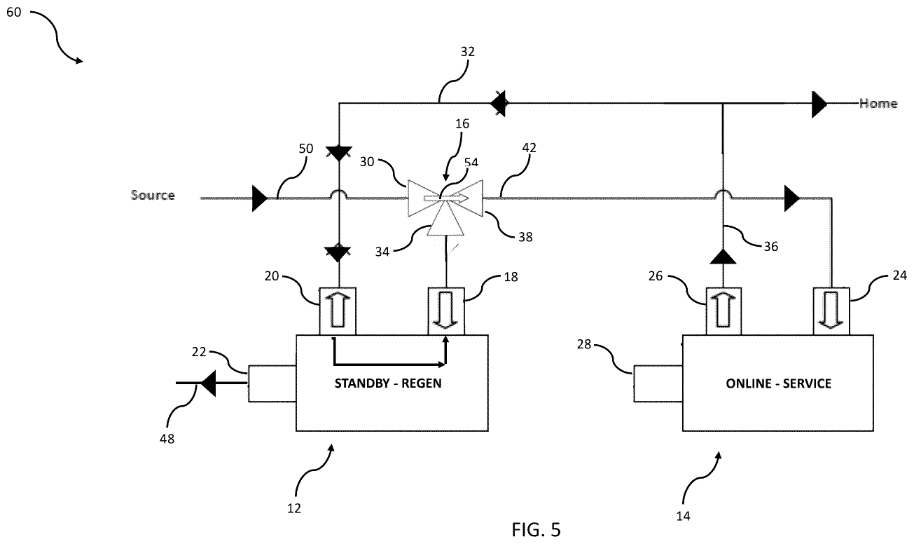

In FIG. 5, the MAV 16 is shown in a second position wherein the MAV 16 places the first water conditioner 12 in a regeneration mode and the second water conditioner 14 in an online mode. As such, supply water flows from the source through the line 50 into the first port 30 of the MAV 16, out the third port 38 of the MAV 16 (as indicated by arrow 54) and through line 42 into the input port 24 of the second water conditioner 14. The water is conditioned in the second water conditioner 14 and flows out the output port 26 through the lines 36, 32 and to the home. In regeneration mode, the internal valve connects the inlet port 18 to the outlet port 20. As such, the first water conditioner 12 receives water for regeneration through the outlet port 20 and discharges water through the discharge port 22 through line 48 to a drain (not shown).

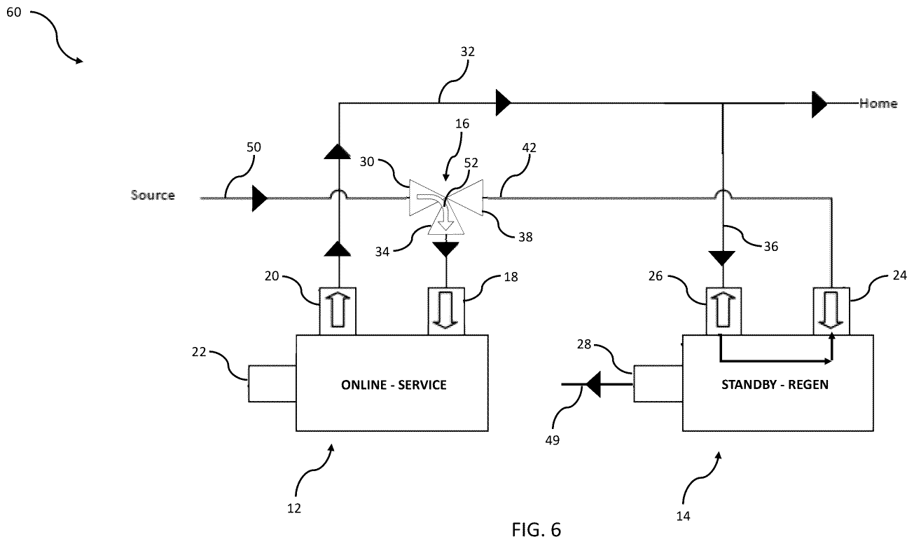

In FIG. 6, the MAV 16 is again shown in the first position but in this example the MAV 16 places the first water conditioner 12 in an online mode and the second water conditioner 14 in a regeneration mode. As such, supply water flows from the source through the line 50 into the first port 30 of the MAV 16, out the second port 34 of the MAV 16 (as indicated by arrow 52) and into the input port 18 of the first water conditioner 12. The water is conditioned in the first water conditioner 12 and flows out the output port 20 through the line 32 and to the home. In regeneration mode, the internal valve connects the inlet port 24 to the outlet port 26. As such, the second water conditioner 14 receives water for regeneration through the outlet port 26 and discharges water through the discharge port 28 through line 49 to a drain (not shown).

A variety of faults may be initiated by the configuration and/or operation of the MAV 16, the first water conditioner 12 and the second water conditioner 14. For example, if both the first water conditioner 12 and the second water conditioner 14 have a dual alt system function activated, then the MAV 16 will provide a dual alt system setup (“DASS”) fault. Additionally, if the first water conditioner 12 and the second water conditioner 14 are not both water softeners or both water filters, then the MAV 16 will provide a DASS fault. If the flow meters 144 of the first water conditioner 12 and the second water conditioner 14 are both disabled, then the MAV 16 will provide a DASS fault. Additionally, if both the first water conditioner 12 and the second water conditioner 14 do not have a regeneration event capacity, then the MAV 16 will provide a DASS fault. Finally, if one of the first water conditioner 12 and the second water conditioner 14 detects that the other is a twin tank (where a single valve controls two resin tanks), then the MAV 16 will provide a DASS fault.

Although water treatment system 10 is depicted with two water softeners and two control modules to illustrate aspects of the present disclosure, other applications are envisioned. For example, some water treatment systems may use a single control module to control multiple tanks, or may have both tanks operating as filters. Another application for twin-tank control units is to have one tank operate as a dedicated filter for applications with very high amounts of insoluble solids and materials in the water. One such example is an iron filter, which is used in installations with incoming water with high iron content. For filtration, the tank setup can be the same as the resin tank 62 or 64 described below, except the water softening resin is replaced with filter media.

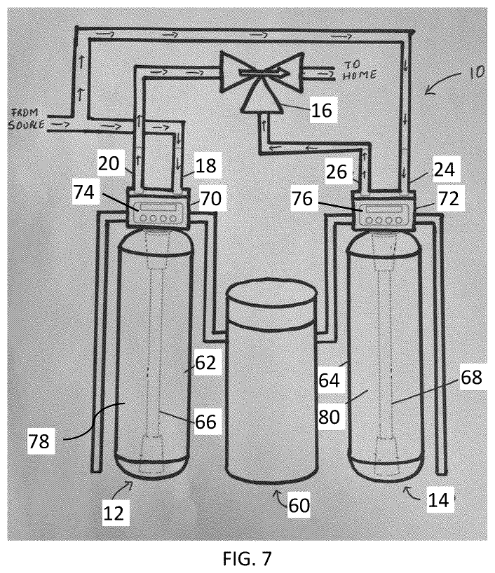

Referring to FIG. 7, another representation of the exemplary water treatment system 10 as configured in FIGS. 1-3 is shown, illustrating that the dual alt system may be set up with a single brine tank 60. Typically, dual alt systems have two brine tanks, one for each water conditioner. The water treatment system 10 includes a brine tank 60, a MAV 16, and two water softeners 12, 14. Water softeners 12, 14 are fluidly connected to the MAV 16 and to the brine tank 60. In some embodiments, the water softeners 12, 14 may be fluidly connected to each other. In the illustrated embodiment, the water softener 12 is identical to the water softener 14. In other embodiments, one water softener can be substituted with a water filter, or additional water softeners and water filters may be included in the water treatment system 10.

The water softeners 12, 14 include resin tanks 62, 64, distributor tubes 66, 68, valve bodies 70, 72, and control modules 74, 76, respectively. The distributor tubes 66, 68 span the lengths of the resin tanks 62, 64 and function to deliver fluid to the bottom of the resin tanks 62, 64. The valve bodies 70, 72 are fluidly connected to the distributor tubes 66, 68, to the MAV 16, and to the brine tank 60. the resin tanks 62, 64 contain resin beds 78, 80.

### Remain Capacity

This aspect of the disclosure relates to the capturing of over-servicing of the resin by reducing the remaining water capacity (Remain Capacity) to 0 gallons (or liters) and then to a negative number. By determining the Remain Capacity as a negative number, the real amount of resin service can be compared to the serviced amount.

As water is treated by, for example, the water softener 12 of FIG. 7, the Remain Capacity of the resin bed 78 becomes reduced and requires regeneration using a brine solution from the brine tank 60. The amount of brine solution needed by the water softener 12 for regeneration has a non-linear correlation to the amount of water that has been treated. As the resin bed 60 becomes more depleted, the ratio of the amount of brine solution needed for regeneration to the amount of water treated increases significantly. When the water softener 12 detects via a sensing unit 140 (FIG. 8) that the resin bed 60 is close to, or completely, depleted, the controller 150 of the water softener 12 automatically increases the amount of brine solution available for regeneration. The amount of water that can be treated by the water softener 12 before the resin bed 78 is completely depleted is stored as the treatment capacity in a memory 178 of the controller 150.

To determine how much the Remain Capacity of the resin bed 78 has been depleted, a flow meter 146 of the sensing unit 140 determines how much water has been treated by water softener 12 and the controller 150 compares the amount of water already treated to the treatment capacity of the water softener 12. Once the controller 150 determines that the amount of water treated has exceeded the treatment capacity of the water softener 12, regeneration is automatically triggered with an increased amount of brine solution. This systematic method of increasing brine solution may provide benefits over typical water softeners which automatically increase the supply of brine solution after a designated number of regeneration events. This is because increasing the supply of brine solution regardless of the amount of water that has been treated often leads to excessive salt consumption and an increased cost to the end user.

In some instances, regeneration might not be possible while the water softener 12 is in operation, and the amount of water treated may exceed the treatment capacity, leading to over-depletion of resin bed 78. The water softener 12 of the present disclosure accounts for this over over-depletion of the resin bed 78 by recording the Remain Capacity as a negative number. When the sensing unit 140 detects that the amount of water treated has reached the treatment capacity of the water softener 12, a remaining-capacity indicator 170 (FIG. 8) of the user interface 144 displays the number zero. As the water softener 12 continues to treat water the number displayed on remaining-capacity indicator 170 becomes negative. The control module 74 then instructs an injector assembly (not shown) to provide an increased amount of brine solution to ensure that the resin bed 78 is completely replenished from its over-depleted state. This method employed by the water softener 12 may provide benefits over that of typical water softeners which only account for complete depletion of the resin beds and do not account for over-depletion of the resin beds.

More specifically, calculating the Remain Capacity of a resin tank is useful in identifying when to perform a regeneration sequence to recharge the resin. The Remain Capacity is calculated by subtracting the amount of water the resin can service (i.e., the Regen Capacity) from the amount of water the resin has already serviced. In the water softener and filter industry, the Regen Capacity is set to a conservative value (i.e., a lower value) than the actual amount the resin can service (i.e., the Actual Capacity). In conventional systems, over-servicing the resin causes the Remain Capacity to go to 0 gallons (or liters) and the system stops capturing any additional service. In this manner, the Remain Capacity does not reflect the actual amount of water that has been serviced. The embodiments of the present disclosure capture the over-servicing of the resin by reducing the Remain Capacity to 0 gallons (or liters) and then to a negative number. In this manner, the actual amount of resin service can be compared to the Actual Capacity. Stated another way, the Regen Capacity is lower than Actual Capacity of a resin. Typically, the Remain Capacity is based off the Regen Capacity which then does not allow comparison to the Actual Capacity. It should be understood that the principles of the present disclosure apply to both types of resin-water Softener and mineral-filter.

For example, if the Remain Capacity was determined to be 10% negative, accommodating for this by adding additional salt could, for example, return the Remain Capacity to 90% for next regen cycle, so the system recovers more quickly. The present system recognizes the negative Remain Capacity and provides alternate salt fill to go up to more than 50% capacity and reduces the next capacity by the previous negative amount. Eventually, the system returns to 100% capacity, especially if the Remain Capacity does not go negative during the next regeneration cycle. This may result in longer resin life and provides a system with a Remain Capacity that correlates better to the true capacity of the resin.

### Regeneration on Specific Day of the Week

Unlike typical water treatment systems which specify an amount of time between performance of regeneration (typically in terms of hours from the start of one regeneration cycle to the start of the next regeneration cycle), a water treatment system, such as water softener 12, according to the present disclosure allows a user to specify a day of the week for regeneration to occur. This proves beneficial in applications where predefined weekly routines require water treatment systems to have maximum operational capacity before the day of high usage. For example, for applications in a church, maximum operational capacity may be needed every Wednesday and every Sunday.

As indicated above with reference to FIG. 8, the control module 74 of the water softener 12 includes a real-time-clock 148 which uses a calendar to keep track of time and to determine when a particular time of a particular day has been reached. Unlike conventional clocks which keep track of time from midnight to midnight, the real-time clock of the present disclosure includes a calendar function which enables tracking the day of the week, the day of the month, and the year, and may also account for leap years. A user provides input to the control module 74 via user interface 144 through a regeneration scheduler 174 specifying what time(s) and day(s) of the week regeneration should occur. The real-time-clock 148 detects when the specified time and day has been reached which causes the control module 74 to initiate regeneration to reach the maximum operational capacity of the water softener 12.

### Water Softener/Filter Ancillary Device Control During Regeneration

As water softeners and filters become more advanced in functionality and cleanse more hazardous contaminants, ancillary devices, such as MAVs and relays, should be tightly synchronized with the regeneration operation. As indicated above, MAVs change the pathway of water by closing or opening either a 2-way or a 3-way valve. Relay operation can actuate solenoids, dosing pumps, or other devices. These ancillary devices must be synchronized to the regeneration operation, which moves water through internal passageways within the main valve of the water treatment device to refreshen the resin bed. The regeneration process moves either a piston or other mechanical device to various positions or stages, to allow different internal passageways of the water treatment device to close or open. Once a piston or mechanical device is in a position or stage, it is held there for the duration of the stage.

The water softener and filter industry typically relies on synchronizing ancillary devices to the regeneration process by specifying the starting stage and duration of being open (for a MAV) or active (for a relay). In the following description, the open state of the MAV(s) is described in terms of the MAV(s) being “activated” and the closed state of the MAV(s) is described in terms of the MAV(s) being “deactivated,” in the same way as the relay(s) are described as being “activated” or “deactivated.” In this manner, the ancillary device(s) can become active across multiple stages. However, the advanced functionality of water softeners and filters (collectively, “water treatment devices”) now allows stage times to change based on best practices in refreshing the resin. The water treatment devices also now cleanse hazardous contaminants where the fluid pathways should be tightly synchronized to the regeneration process. Cross contamination can occur if the ancillary device(s) does not operate during the correct stage at the correct time.

In the embodiments of the present disclosure, a user is enabled to specify the Stage ON time, the Stage ON Offset, the Stage OFF time, and the Stage OFF Offset for each ancillary device. For relay operation, the relay becomes active (is activated) at a designated Stage ON time plus the Stage ON Offset. The relay becomes inactive (is deactivated) at the Stage OFF time plus the Stage OFF Offset. For MAV operation, the MAV moves to the closed position (is deactivated) at the Stage ON time plus the Stage ON Offset. The MAV moves to the opened position (is activated) before the Stage OFF time plus the Stage OFF Offset. The activated and deactivated positions may be designated upon installation. In this manner, the regeneration stage times can change for each regeneration operation while the ancillary device(s) operation is tightly synchronized. Among other things, this approach may prevent cross contamination by ensuring that the piston or mechanical device is in position for the designated period before operation.

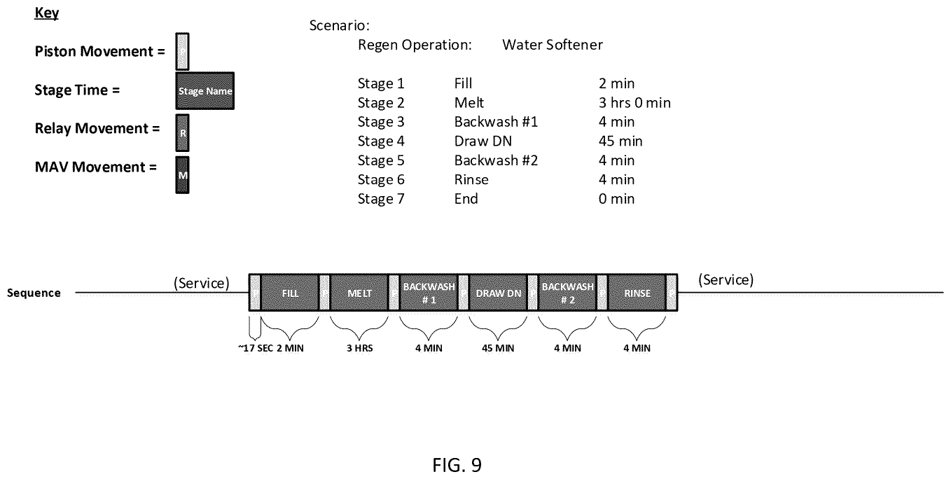

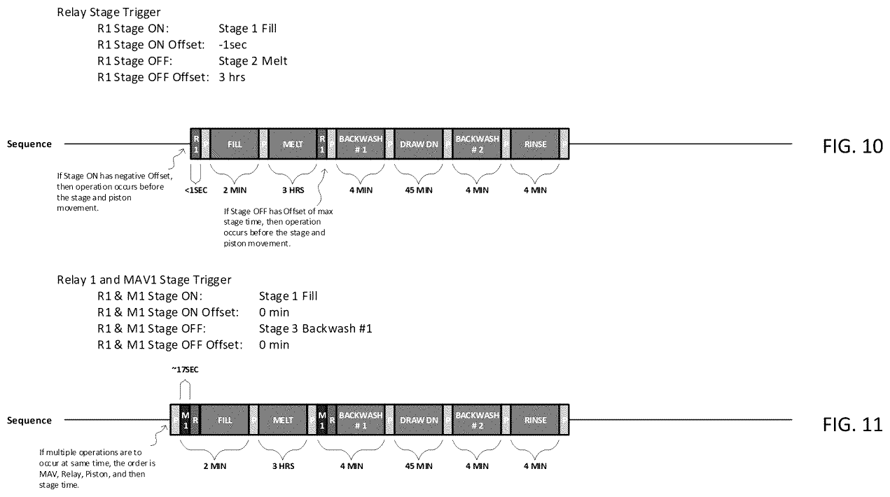

FIG. 9 depicts an example scenario of a water softener regeneration operation. In this example, the piston movement is shown depicted before each stage of the regeneration operation (i.e., fill, melt, backwash #1, drawn down, backwash #2, rinse and end, which follows the rinse stage). In this example, no relay or MAV movement is depicted. The time of operation associated with each of the stages of regeneration are shown in the table of FIG. 9. These times are used in each of the scenarios depicted in FIGS. 10-15 which are described below.

FIG. 10 shows the water softener regeneration operation scenario with the addition of a depiction of the operation of a relay R1 as an ancillary device. In this example, the fill stage takes 2 minutes and the melt stage takes 3 hours, as is shown in FIG. 9. The Stage ON Offset for the relay R1 is set to −1 second. As such, the relay is activated 1 second before the piston is moved in advance of the fill stage. The Stage OFF Offset for the relay R1 is 3 hours, which is the maximum stage time for the melt stage. Thus, the relay R1 is deactivated immediately following the melt stage, before the piston is moved in advance of the backwash #1 stage.

In FIG. 11, the operation of a MAV (i.e., MAV1) and the relay R1 is depicted as ancillary devices. In this example, the Stage ON Offset for the relay R1 and the MAV1 is zero minutes relative to the fill stage and the Stage OFF Offset for the relay R1 and the MAV1 is zero minutes relative to the backwash #1 stage. Since the relay R1 and the MAV1 are set to be activated at the same time relative to the fill stage, after the piston is moved, the order of activation is the MAV1, then the relay R1, followed the fill stage. In other embodiments, some or all of this order of operation may be reversed. The same is true for the deactivation of the MAV1 and the relay R1 relative to the backwash #1 stage.

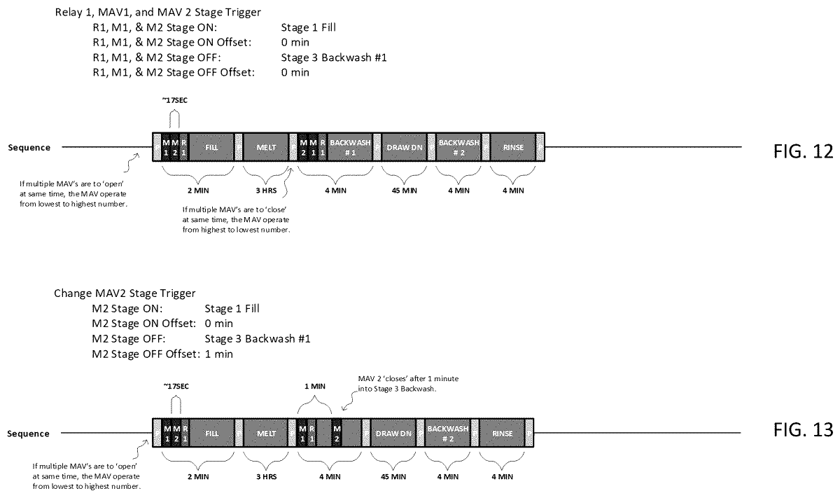

Referring now to FIG. 12, the operation of two MAVs (i.e., MAV1 and MAV2) and the relay R1 is depicted as ancillary devices. In this example, the Stage ON Offset for the relay and both MAV1 and MAV2 is zero minutes relative to the fill stage and the Stage OFF Offset for all of the devices is zero minutes relative to the Backwash #1 stage. Since the relay R1 and the MAVs are set to be activated at the same time relative to the fill stage, after movement of the piston the order of activation is the MAVs (lowest number to highest number), the relay R, then the fill stage. Again, some or all of this order of operation may be reversed in other embodiments. The deactivation of the devices in the figure shows that when MAVs are scheduled to be deactivated at close to the same time, the MAVs are deactivated starting with the highest number MAV (i.e., MAV2) followed by the lowest number MAV (i.e., MAV1), then followed by the relay R1.

FIG. 13 depicts an example similar to FIG. 12 except that the MAV2 Stage OFF Offset is changed to 1 minute. Thus, the activation sequence of the MAVs and the relay R1 is the same as in FIG. 12, but the MAV2 deactivation occurs 1 minute into the backwash #1 stage.

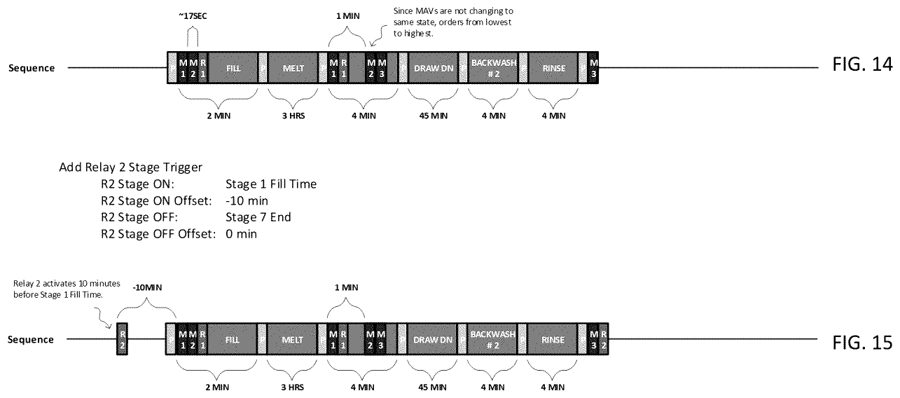

In FIG. 14, a third MAV (i.e., MAV3) is added to the scenario of FIG. 13. The Stage ON Offset for the MAV3 is 1 minute relative to the beginning of the backwash #1 stage. The Stage OFF Offset for the MAV3 is zero minutes relative to the end stage following the rinse stage. Thus, the control of the MAV1, the MAV2 and the relay R1 is the same as is shown in FIG. 13. Since the MAV2 is scheduled to be deactivated 1 minute after the beginning of the backwash #1 stage and the MAV3 is scheduled to be activated at the same time (i.e., the MAV2 and the MAV3 are scheduled to change states simultaneously, but not change to the same state), the order of changing the states of the MAV2 and the MAV3 is from the lowest number MAV to the highest number MAV. Thus, the MAV2 is deactivated 1 minute into the backwash #1 stage and the MAV3 is activated immediately thereafter. The MAV3 is deactivated zero minutes following the end stage which follows the rinse stage.

Finally, in the scenario depicted in FIG. 15 a second relay R2 is added to the scenario depicted in FIG. 14. The relay R2 has a Stage ON Offset of −10 minutes relative to the beginning of the fill stage and a Stage OFF Offset of zero minutes relative to the end stage. As shown, in this scenario the relay R2 is activated 10 minutes before the fill stage begins and is deactivated immediately after the MAV3 is deactivated at the end stage following the rinse stage.

As shown in the examples of FIGS. 10-15, the piston movement always occurs before each of the fill stage, the melt stage, the backwash #1 stage, the draw down stage, the backwash #2 stage, the rinse stage and the end stage. Also, the operations are in order of the MAV(s), the relay(s), the piston and then the regeneration stage. If multiple MAVs or relays are scheduled to be deactivated at same time, then they are deactivated in order of the lowest number to the highest number. If multiple MAVs or relays are scheduled to be activated at same time, then they are activated in order of the highest number to the lowest number. Additionally, if the ancillary device(s) have zero offset, then the piston moves first followed by the ancillary device(s), which is concurrent with stage time. Alternatively, if the ancillary device(s) have an offset set to maximum value, then the ancillary device(s) moves first followed by movement of the piston. If the Stage ON is not the first stage, then the Stage ON Offset has a range of zero seconds to a maximum stage time. On the other hand, if the Stage ON is the first stage, then the Stage ON Offset has a range of −20 minutes to a maximum stage time. Finally, the control module 74 will adjust the Stage OFF and the Stage OFF Offset ranges to prevent deactivation of an ancillary device before the activation operation.

According to the above-described operation of embodiments of the present disclosure, it is possible to control the ancillary device(s) based on the actual movement of the valves of the water treatment device, which can vary in time. In other words, the activation of the ancillary device(s) can occur before or after the piston movement, or anywhere in between piston movements. As such, while the regeneration stage times may change for each regeneration operation, the ancillary device(s) remain tightly synchronized with the stages. As a consequence, cross contamination (e.g., the release of bacteria laden water into the environment) may be prevented by making sure that the piston or the ancillary device(s) are in position for the designated period before operation.

### MAV Software Polarity Flip

As described above, MAVs change water pathways of a water treatment device by energizing a motor that forces the valve to a desired position. Typically, MAVs utilize a DC motor where spin direction changes by reversing the polarity of the signal applied to the motor. For initial commissioning with water treatment devices, the signals on the motor connector must match signals on the controller connector. If the signal polarity does not match, the industry practice is to remove the pins from motor connector and reinstall the pins with their positioned reversed. This practice is undesirable as it is time consuming and may result in bent pins and/or poorly seated pins. According to embodiments of the present disclosure, if the signals on the motor do not match the signals on the controller connector, the polarity of the signals provided to the motor is changed via software on the controller, thereby eliminating the need to modify the position of the pins on the motor connector.

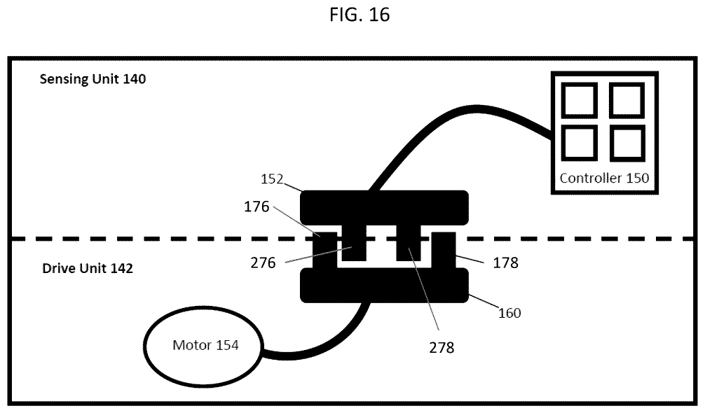

More specifically, and with reference to FIGS. 8 and 16, when installing a water treatment device, the signal polarity on the motor connector 160 for the motor 154 driving the valve of the water treatment device must match the signal polarity on the controller connector 152 coupled to the controller 150 for the device. If the signal polarities do not match, the motor 154 will move in the opposite direction specified by the controller 150. Again as described above, conventionally this problem is addressed during installation by physically swapping the pins 176 and 178 of the motor connector 160 such that the pin 176 is moved to connect with the pin 278 of the controller connector 152 and the pin 178 is moved to connect with the pin 276 of the controller connector 152. This method may damage the pins 176, 178 during removal and/or installation or cause them to be poorly seated. A water treatment device according to the present disclosure provides a software method of matching the signal polarity of the motor connector 160 and the controller connector 152 without having to alter the configuration of the pins 176, 178.

Once the motor cable is connected to the controller 150, the controller 150 is powered-up and informs the expected position of the MAV 16. If the expected position is incorrect, the user sets a parameter to “flip polarity.” In response to this input, the controller 150 records the current position of the MAV as the opposite position. Subsequently, when the controller 150 commands the MAV 16 to operate, the controller 150 applies either a positive or a negative polarity for the forward direction based on recorded position from the polarity flip. The signals applied according to embodiments of the present disclosure based on whether or not a “flip polarity” input is provided by the user are shown in the table below.

| Polarity Flip | Forward Command | Backward Command |
|---|---|---|
| No | +V to +signal | +V to −signal |
| | −V to −signal | −V to +signal |
| Yes | +V to −signal | +V to +signal |
| | −V to +signal | −V to −signal |

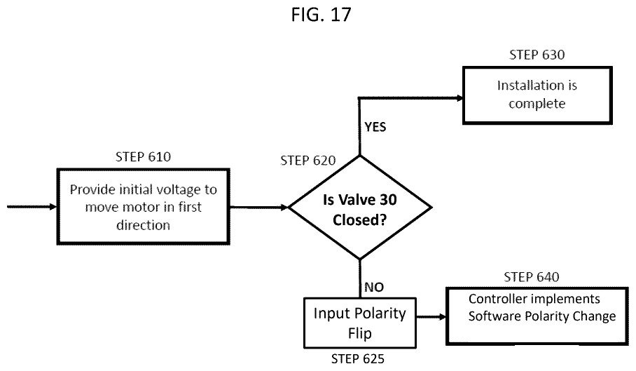

More specifically, and with reference to FIGS. 8, 16 and 17, during installation of the water treatment device, the motor connector 160 and the controller connector 152 are operably connected to allow the controller 150 to communicate with the motor 154 to control its operation. As shown in FIG. 17, in step 610, the user activates the MAV 16 via the controller 150. The controller 150 applies, for example, a positive polarity to the motor 154 until it stops in what the controller 150 initially assumes is a closed position. At step 620, the user then checks the MAV 16 to see if it is in fact in the closed position. If the MAV 16 is closed, then the installation is complete as indicated by step 630. If the MAV 16 is opened, then at step 625 the user selects a “flip polarity” option 172 (FIG. 8) on the user interface 144 of the control module 74.

In step 640, the control module 74 then implements a software change to effectively switch the polarity of the signals supplied to the motor 154 by instructing the controller 150 to send a first signal of an opposite polarity to the motor connector 160 when it is intended for the motor 154 to move the MAV 16 to the closed position (or in the direction of the closed position), and to send a second signal of a polarity opposite the first signal to the motor connector 160 when it is intended for the motor 154 to move the MAV 16 to the opened position (or in the direction of the opened position). Thus, the control module 74 effectively switches polarity of the direct-current motor 154 by a software change alone without requiring the user to modify the configuration of the pins 176, 178.

According to the embodiment described above, the setup of the MAV 16 is simplified requiring no modifications to the factory-made wiring harness. As such, there is no resulting impact on the warranty associated with the MAV 16, bent or poorly seated pins are avoided and downtime of the water treatment device is reduced.

### ADDITIONAL DESCRIPTION

The user interface 144 depicted in FIG. 8 may include several indicators on a display screen. In the illustrated embodiment, the user interface 144 includes an in-service indicator 162, a time-of-day indicator 164, a fault-code indicator 168, a remaining-capacity indicator 170, a flip polarity option 172, and a regeneration scheduler 174.

The drive unit 142 may include gears 156 and the motor 154. The motor 154 is directly connected to the gears 156, which are in turn connected to the valve piston to move the piston to the various positions described herein. In some embodiments, the drive unit 142 may also include relays to actuate ancillary devices, such as solenoids, and dosing pumps.

In a dual alternate water treatment system, such as that shown in FIGS. 1-7, the control modules 74 communicate with each other to designate one of valve bodies as the master controller in order to simplify setup and interoperability between valves. Only one of valve bodies will be designated as the master controller at any time. If more than one master controller is designated, the user interface 144 displays “system setup error” on the fault-code indicator 168 indicating that the system has been installed incorrectly. This dual alternate system is only needed if the water treatment systems are both water softeners or both water filters. If a user attempts to set up a dual alternate system and the water treatment systems are not both water softeners or water filters, the user interface 144 will display the “system setup error” indicating that the system has been installed incorrectly.

The MAV 16 may not be actuated over extended time periods. Over such time periods, there is a tendency for debris to accumulate in the MAV 16, which may interfere with its operation. To prevent the accumulation of debris, the MAV 16 may be periodically actuated in a manner that moves the valve back and forth in a rocking motion. In one embodiment, the MAV 16 is first energized in a first direction for one second and then in a second, opposite direction for half a second. The MAV 16 is again actuated in the first direction for half a second such that the MAV 16 is back to the original position. This sequence is repeated, for example, every 14 days to ensure that debris does not accumulate around the ports. It will be understood by those of skill in the art that the sequence and timing of the periodic motion described above may differ depending on the application. For example, actuation of the MAV 16 in the first and second direction may occur in any order and for any amount of time. The cadence of this sequence may differ from the 14-day period specified and may be, for example, every week or every day.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for regenerating water softening resin in a tank, the method comprising the steps of:
preventing water from flowing through the water softening resin;
determining a quantity of water treated by the water softening resin;
determining a treatment capacity of the water softening resin; and
passing a quantity of brine solution through the water softening resin, the quantity of brine solution corresponding to the treatment capacity of the water softening resin and the quantity of water treated by the water softening resin that exceeds the treatment capacity of the water softening resin.

2. The method of claim 1, wherein determining a quantity of water treated by the water softening resin includes sensing, by a flow meter, a quantity of water that has passed through the water softening resin since a previous regeneration operation.

3. The method of claim 1, wherein passing a quantity of brine solution through the water softener resin includes, automatically initiating, by a controller, a regeneration operation using an increased amount of brine solution.

4. A water treatment device, comprising:
a controller operably connected to a tank containing a water softening resin;
a sensor in communication with the controller and configured to provide date for determining a treatment capacity of the water softening resin and for determining a quantity of water treated by the water softening resin; and
a valve configured to pass water to be treated through the water softening resin;
wherein the controller is configured to monitor a remaining treatment capacity of the water softening resin by subtracting the quantity of water treated by the water softening resin from the treatment capacity of the water softening resin; and
wherein the controller is configured to record the remaining treatment capacity, as a negative value, when the quantity of water treated by the water softening resin exceeds the treatment capacity of the water softening resin.

5. The water treatment device of claim 4, wherein the controller is further configured to respond to the quantity of water treated by the water softening resin exceeding the treatment capacity of the water softening resin by causing an increased amount of brine solution to be provided to the water softening resin to ensure that the water softening resin is replenished.

6. A method for treating water using at least two water conditioners, the method comprising the steps of:
providing a three-way motor-actuated valve (MAV) operatively connected to at least one input port of each of the at least two water conditioners;
determining which of the at least two water conditioners requires regeneration; and
actuating the MAV to prevent water from flowing through the input port of the water conditioner requiring regeneration and to allow water to flow through the at least one input port of the other water conditioner which does not require regeneration.

7. The method of claim 6, further comprising providing treated water from an output port of the other water conditioner to the at least one water conditioner requiring regeneration.

8. The method of claim 6, wherein the at least two water conditioners are coupled to a single brine tank.

9. A method for treating water using at least two water conditioners, the method comprising the steps of:
providing a three-way motor-actuated valve (MAV) operatively connected to at least one output port of each of the at least two water conditioners;
determining which of the at least two water conditioners requires regeneration; and
actuating the MAV to prevent water from flowing through the output port of the water conditioner requiring regeneration and to allow water to flow through the at least one output input port of the other water conditioner which does not require regeneration.

10. The method of claim 9, further comprising providing untreated water from a water source to the input port of the at least one water conditioner requiring regeneration.

11. The method of claim 9, wherein the at least two water conditioners are coupled to a single brine tank.

12. A method of controlling a direct-current motor, the method comprising the steps of:
providing a controller operatively connected to the direct-current motor;
providing an initial voltage of a first polarity to actuate the direct-current motor in a first direction using the controller;
determining whether the direct-current motor rotates in the first direction or in a second direction; and
responding to the direct-current motor rotating in the second direction by automatically configuring software executed by the controller to provide a subsequent voltage of a second polarity which is opposite of the first polarity to the direct-current motor to actuate the direct-current motor in the first direction.

13. The method of claim 12, further comprising displaying an input polarity flip option on a user interface of the controller and receiving, via the user interface, an input from a user indicating that the direct-current motor rotates in the second direction after providing the initial voltage to the direct-current motor.

14. The method of claim 12, wherein the initial voltage and the subsequent voltage are provided from the controller to a controller connector which is connected to a motor connector connected to the direct-current motor.

15. A method for regenerating water softening resin of a water treatment system comprising the steps of:
providing a valve comprising at least one piston;
providing at least one ancillary device operably associated with the valve;
providing a tank containing the water softening resin, the tank operatively connected to the valve;
receiving a user input for at least one regeneration stage of a Stage ON time, a Stage ON Offset, a Stage OFF time and a Stage OFF Offset for the at least one ancillary device;
activating the at least one ancillary device at the Stage ON time plus the Stage On Offset; and
deactivating the at least one ancillary device at the Stage OFF time plus the Stage OFF Offset;
whereby the activation and deactivation of the at least one ancillary device is independent of a duration of the at least one regeneration stage.

16. The method of claim 15, wherein the at least one ancillary device is one of a relay or a motor-actuated valve.

17. The method of claim 15, wherein activation of the at least one ancillary device may occur before or after a movement of the piston corresponding to the at last one regeneration stage, or between movements of the piston corresponding to a first regeneration stage and a subsequent second regeneration stage.
